(19) United States
(12) Patent Application Publication
(10) Pub. No.: US 2024/0001587 A1
(43) Pub. Date: Jan. 4, 2024

(54) MANUFACTURED WOOD PANELS WITH ELEVATED LEVELS OF ZINC BORATE ADDITIVES FOR IMPROVED SURFACE PROPERTIES

(71) Applicant: LOUISIANA-PACIFIC CORPORATION, NASHVILLE, TN (US)

(72) Inventors: BRIAN PATRICK BUFFIN, SELAH, WA (US); JEFFREY RICHARD JAYNE, IRON MOUNTAIN, MI (US); CHRISTOPHER DALL, NASHVILLE, TN (US)

(21) Appl. No.: 18/218,476

(22) Filed: Jul. 5, 2023

Related U.S. Application Data
(60) Provisional application No. 63/358,205, filed on Jul. 4, 2022.

(51) Int. Cl. B27N 3/12; E04C 2/24; E04C 2/52; B27N 3/04; B27N 3/06; B27N 1/00

(52) U.S. Cl. CPC B27N 3/12; E04C 2/246; B27N 1/00; B27N 3/04; B27N 3/06; E04C 2/526

(57) ABSTRACT

A method or process for a system for applying high, elevated levels of zinc borate additives to composite or manufactured wood panels, such as oriented strand board, for improved surface antifungal and anti-termite properties. Zinc borate is applied to one or more surface layers of a manufactured wood panel at approximately 2.0% (m/m) or higher, more preferably above 2.0% (m/m) to approximately 2.5% (m/m), which produces the surprising result of resisting surface fungal growth. In particular, OSB panels generated from Aspen and Southern Yellow Pine (SYP) wood species are successfully treated with zinc borate levels of at least approximately 2.0% (m/m), and found to resist surface fungal growth.

This application claims benefit of and priority to U.S. Prov. No. 63/358,205, filed Jul. 4, 2022, which is incorporated herein its entirety by specific reference for all purposes.

### FIELD OF INVENTION

This invention relates to a system for applying relatively high, elevated levels of zinc borate additives to manufactured wood (e.g., oriented-strand board, OSB) panels for improved surface antifungal and anti-termite properties.

### BACKGROUND OF INVENTION

Wood and manufactured-wood materials are subject to decay or rot from various fungal and/or mold microorganisms, as well as attack by wood-eating termites. Various additives or ingredients have been utilized for many years to help protect these wood materials. Treatments include borate compounds such as zinc borate, calcium borate, and boric acid.

Borates are used as broad-spectrum wood preservatives with fungicidal and insecticidal properties. Many borates, such as boric acid and borax, are commonly used for treating solid wood materials and products, typically by some form of dipping or pressure treatment. These types of borates, however, are very soluble in water, and thus are incompatible with most resin adhesive systems used for the manufacture of composite or engineered wood products, which are often used in building wall and roof assemblies.

Building wall and roof assemblies are typically layers of several materials, each performing one or more specific functions, that typically are installed separately on the site in which the building is being constructed. Proper installation of the various layers individually and in combination creates challenges not only for the designer, but also for the installers.

A typical layer in most such assembles is a wood panel product, or an integral composite engineered panel product, including, but not limited to, engineered wood composite products. Wood-based composites have been found to be acceptable alternatives in most cases to dimension lumber or veneer-based wood paneling (e.g., softwood plywood). In general, wood-based composites include particle board, oriented strand board (OSB), wafer board, as well as medium density fiberboard (MDF), with the wood-based composites typically formed from a wood material combined with a thermosetting adhesive to bind the wood substrate together (the adhesive also may be referred to as a “binder”). Often times, the adhesive is combined with other additives to impart additional properties to the wood composites. Additives can include fire retardants, insecticides, water repellants, and preservatives. A significant advantage of wood-based composites is that they have many of the properties of plywood, but can be made from lower grade wood species and waste from other wood product production, and can be formed into panels in lengths and widths independent of size of the harvested timber.

A major reason for increased presence in the marketplace of the above-described product alternatives to dimension lumber or plywood is that these materials exhibit properties like those of the equivalent dimension lumber or plywood, especially, the properties of retaining strength, durability, stability and finish under exposure to expected environmental and use conditions. A class of alternative products are multilayer oriented wood strand boards, particularly those with a layer-to-layer oriented strand pattern, such as OSB. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. Nos. 3,164,511, 4,364,984, 5,425,976, 5,470,631, 5,525,394, 5,718,786, and 6,461,743, all of which are incorporated herein in their entireties by specific reference for all purposes.

Certain oriented board products can be made from flakes that are created from debarked round logs by placing the edge of a cutting knife parallel to a length of the log and the slicing thin flakes from the log. The cut flakes are subjected to forces that break the flakes into strands having a length parallel to the grain of the wood several times the width of the strand. The strands can be oriented on the board-forming machine with the strands predominantly oriented in a single (e.g., cross-machine) direction in one (e.g., core) layer and predominantly oriented in the generally perpendicular (machine) direction in adjacent layers. The various layers are bonded together by natural or synthetic resins under heat and pressure to make the finished product. Oriented, multilayer wood strand boards of the above described type are produced with bending, tensile strengths and face strengths comparable to those of commercial softwood plywood.

Two commonly used adhesives in the manufacturing of OSB and other engineered wood products are polymeric diphenylmethane diisocyanate (pMDI or MDI) and phenol formaldehyde (PF) resins. In general, pMDI performs better than PF as a wood adhesive, particularly when exposed to moisture. However, pMDI has a higher unit price and often is in limited supply due to its wide applications in other industries (e.g., foam industry). Further details of these and other wood adhesives are discussed more fully in Wang et al, U.S. Pat. No. 10,100,232 (issued Oct. 16, 2018), which is incorporated herein in its entirety by specific reference for all purposes.

Zinc borate has been used successfully at low levels with some resin adhesive systems used for manufacturing composite wood products. Their low solubility, however, can cause specific problems, such as allowing some fungal decay in lower relative humidity environments. Further details are discussed more fully in Knudson, et al., U.S. Pat. No. 4,879,083; and Lloyd, et al., U.S. Pat. No. 8,119,031 (issued Feb. 21, 2012), both of which are incorporated herein in their entireties by specific reference for all purposes.

More particularly, zinc borate at low levels of around 1.5% (m/m) or lower is known to impart termite and rot resistance in the interior of composite wood-based products. However, the prior art indicates that zinc borate is not efficacious as a treatment against surface mold. Accordingly, there is a need for composite wood panels that can resist surface mold growth as well as attack by termites.

### SUMMARY OF INVENTION

In various exemplary embodiments, the present invention comprises a method or process for a system for applying high, elevated levels of zinc borate additives to composite or manufactured wood panels, such as OSB, for improved surface antifungal and anti-termite properties. More particularly, the present invention comprises a new method of application of zinc borate to one or more layers of a manufactured wood panel (e.g., OSB) at approximately 2.0% (m/m) or higher, more preferably above 2.0% (m/m) to approximately 2.5% (m/m), which produces the surprising result of resisting surface fungal growth. In particular, OSB panels generated from Aspen and Southern Yellow Pine (SYP) wood species are successfully treated with zinc borate levels of at least approximately 2.0% (m/m), and found to resist surface fungal growth.

### BRIEF DESCRIPTION OF THE DRAWINGS

FIG. 1 shows an example of an OSB forming line.

FIG. 2 shows an example of an OSB forming line with the surface layers of the mat (top layer and bottom layer) treated with ZnB in accordance with the present invention.

FIG. 3 shows an example of an OSB forming line with the surface layers of the mat (top layer and bottom layer) treated with elevated levels of ZnB, and the core layer treated with lower levels of ZnB, in accordance with the present invention.

FIG. 4 shows an example of an OSB forming line with the surface layers of the mat (top layer and bottom layer) treated with elevated levels of ZnB, and the core layer treated with lower levels of ZnB, with optional overlays and secondary processing to add radiant barriers and/or insulation layers, in accordance with the present invention.

### DETAILED DESCRIPTION OF EXEMPLARY EMBODIMENTS

In various exemplary embodiments, the present invention comprises a method or process for a system for applying high, elevated levels of zinc borate additives to composite or manufactured wood panels, such as OSB, for improved surface antifungal and anti-termite properties. More particularly, the present invention comprises a new method of application of zinc borate to one or more layers of a manufactured wood panel (e.g., OSB) at approximately 2.0% (m/m) or higher, more preferably above 2.0% (m/m) to approximately 2.5% (m/m), which produces the surprising result of resisting surface fungal growth. In particular, OSB panels generated from Aspen and Southern Yellow Pine (SYP) wood species are successfully treated with zinc borate levels of at least approximately 2.0% (m/m), and found to resist surface fungal growth when tested against five different microorganisms by the ASTM G21-15 “Standard Practice for Determining Resistance of Synthetic Polymeric Materials to Fungi” method (reapproved 2021, and as may be updated thereafter). Test results and/or the prior art indicate that lower levels of zinc borate (e.g., below about 1.0 m/m) are not as effective at resisting surface mold growth.

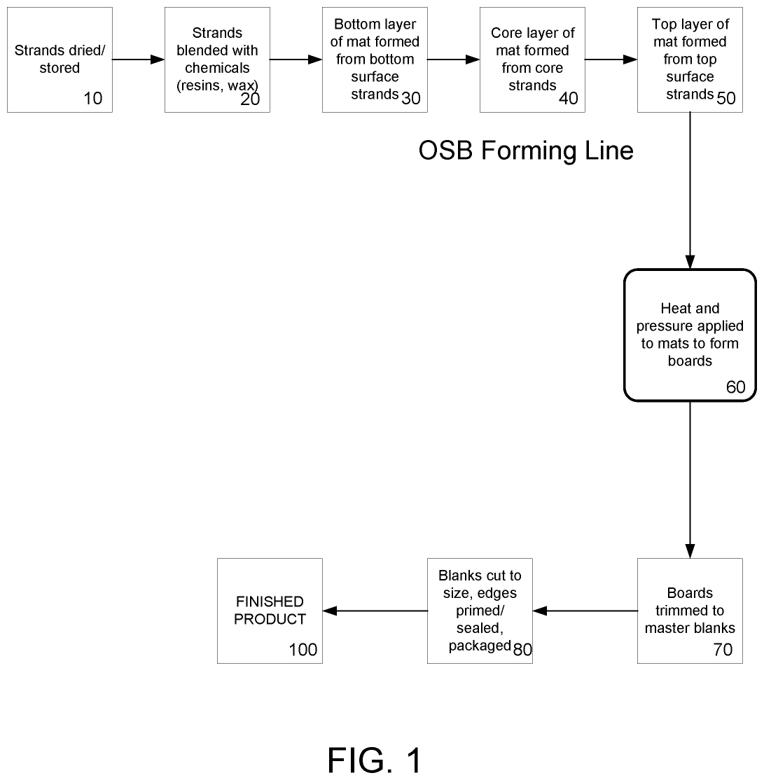

The composition of a typical manufactured or engineered wood-based panel (e.g., OSB) includes multiple layers of oriented strands of primarily Aspen or SYP wood species, along with a portion of other wood species. Two commonly used adhesives in the manufacturing of OSB and other engineered wood products are polymeric methylene diphenyl disocyanate (pMDI) and phenol formaldehyde (PF) resins. As seen in FIG. 1, lignocellulosic strands are dried and stored, 10, then resins (e.g., pMDI and/or PF) and wax are blended 20 with the wood strands making up the various layers (e.g., bottom 30, core 40, and top 50) prior to mat formation. The strands for all layers may be treated uniformly (i.e., blended with resin and wax together), or separately. The mat is then subjected to heat and pressure in a press 60 to form boards, which typically are trimmed to master blanks 70, and subject to further processing (cutting, priming, edge priming/sealing, labeling, packaging, and the like) 80, to produce the finished product 100. The manufacturing of engineered wood products (such as, but not limited to, OSB, laminated strand lumber, laminated veneer, or plywood) typically are produced by various primary (and sometimes secondary) pressing processes, as described above.

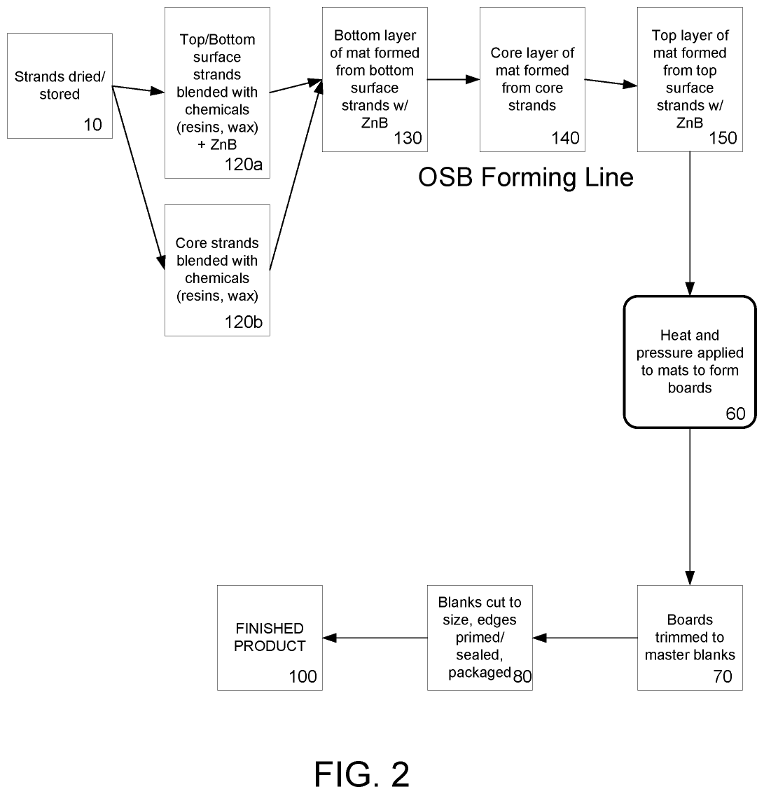

In one embodiment of the present invention, as seen in FIG. 2, zinc borate (ZnB) at an elevated level or concentration (as described above) 120a is added to the wood strands making up the surface (or outer) layers of the finished OSB panel. Alternatively, the ZnB at an elevated level may be added to just the wood strands making up the top surface layer, with the ZnB in the bottom surface layer added at a different level. The strands for the bottom layer may be blended with resins and wax without ZnB The strands for the top and bottom layer may be blended together, or separately.

The ZnB may be added with the resins and wax in the same blending process, as described above, or separately, after the resin/wax blending. The core strands may be blended with resins and wax without ZnB 120b. The treated strands are then arranged 30, 40, 50 as layers to form a mat in an OSB processing line, and then pressed to a desired thickness, under specified elevated pressure and temperature 60, to form the OSB panel.

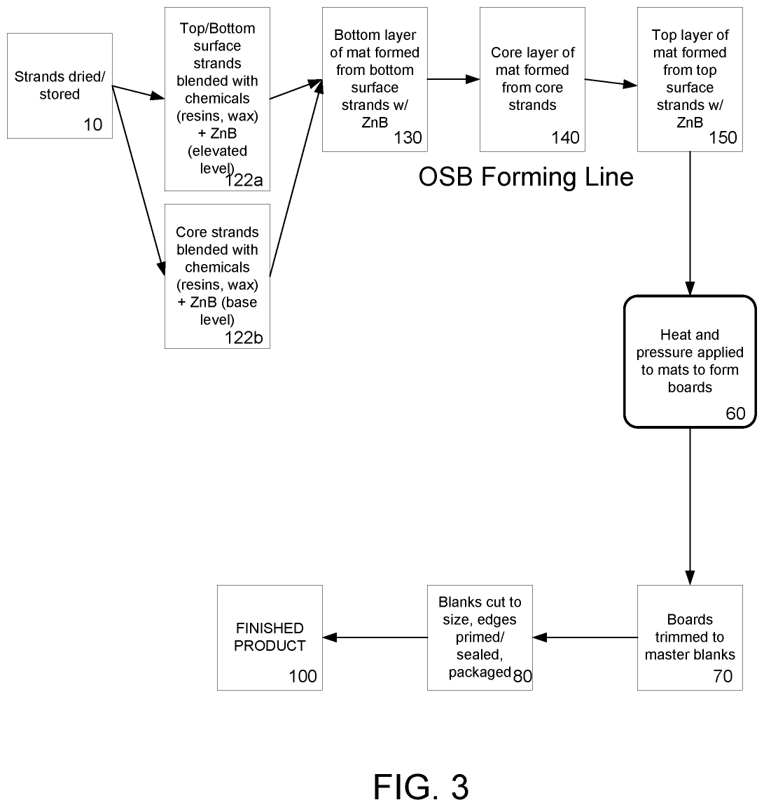

In several embodiments, the core layer also is treated with ZnB 122b. The level of ZnB in the core layer may be the same as in the surface layers, or, as shown in FIG. 3, the level of ZnB in the core layer may be substantially lower than the level in the surface layer or layers 122a. A different amount can be added to the wood strands making up the core layer or layers separately from the amount added to the wood strands making up the surface layer or layers. In an alternative embodiment, a base level of ZnB may be added to all of the wood strands, and then additional ZnB may be added to the wood strands making up the surface layer or layers.

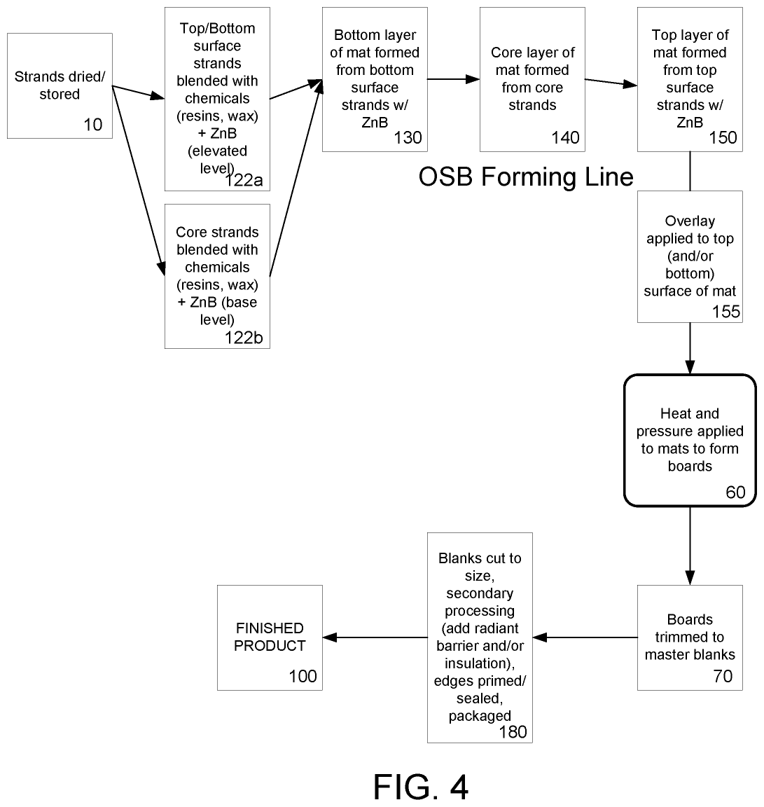

A multi-layered composite wood product 110 produced by the present invention may comprise a panel or board, a structural panel for a wall or roof, a wall panel or board, and/or a roofing panel or board. As seen in FIG. 4, these may be manufactured to incorporate (i) an overlay layer or layers, such as a resin-impregnated paper overlay layer or weather-resistant or water-resistant barrier (WRB) layer on a face, or both faces, of the product (e.g., a structural wall or roofing panel with a WRB layer on the outer face) 155, (ii) a radiant barrier layer on a face, or both faces, of the product 180, and/or (iii) a insulation layer, such as a foam insulation layer, on a face, or both faces, of the product 180. Such layers may be integrated with the panel or board at the factor as part of the primary manufacturing process or a secondary manufacturing process. Combinations of the above may be applied, such as a panel with a WRB layer on the outer face and a radiant barrier layer or foam insulation layer on the inner face, or a panel with foam insulation layer on the outer face and a radiant barrier layer on the inner face.

Zinc borates usable in the present invention include natural and/or synthetically produced zinc borates (ZnO⋅B₂O₃), such as, but not limited to, zinc polytriborates (with a ZnO⋅B₂O₃ ratio of 2:3) and hydrated zinc borates. Examples include, but are not limited to, the following: 2ZnO⋅3B₂O₃⋅3.5H₂O; 2ZnO⋅3B₂O₃⋅7H₂O; 2ZnO⋅3B₂O₃⋅7.5H₂O; 3ZnO⋅5B₂O₃⋅14H₂O; ZnO⋅5B₂O₃⋅14H₂O; ZnO⋅B₂O₃⋅2H₂O; 2ZnO⋅2B₂O₃⋅3H₂O; and 4ZnO⋅B₂O₃⋅H₂O.

Accordingly, the present invention comprises a method for producing a manufactured wood product with surface protection against fungal and insect attack, comprising: forming, on a production line, a bottom layer of a manufactured wood mat with bottom layer lignocellulosic strands; forming, on the production line, a core layer of the manufactured wood mat with core layer lignocellulosic strands; forming, on the production line, a top layer of a manufactured wood mat with top layer lignocellulosic strands treated with a first elevated concentration of zinc borate; and applying heat and pressure to the manufactured wood mat to form a manufactured wood product. The bottom layer lignocellulosic strands may be treated with a second elevated concentration of zinc borate

Additional steps include blending all the lignocellulosic strands with a base concentration of zinc borate; and adding additional zinc borate to the top layer lignocellulosic strands sufficient to attain the first elevated concentration of zinc borate, wherein the first elevated concentration is at least 2.0% (m/m), or is greater than 2.0% (m/m). Additionally, the method may comprise the step of adding additional zinc borate to the bottom layer lignocellulosic strands sufficient to attain a second elevated concentration of zinc borate.

The second elevated concentration of zinc borate is equal to the first elevated concentration. The core layer lignocellulosic strands are treated with a third concentration of zinc borate, wherein the third concentration of zinc borate is less than the first concentration of zinc borate.

In some embodiments, the method further comprises the step of, prior to the step of applying heat and pressure, applying a WRB layer to a top surface of the manufactured wood mat. The manufactured wood product may comprise a panel with integrated WRB layer. The WRB layer may comprise a resin-impregnated paper overlay. Independently of the WRB layer, or in conjunction therewith, the method also may comprise the step of affixing a radiant barrier layer and/or insulation layer to a surface of the manufactured wood product. These layers may be affixed to the bottom surface of the manufactured wood product, opposite the WRB layer (when the WRB layer is present). In one embodiment, the insulation layer may be affixed to one surface, and the radiant barrier may be affixed to the other surface.

Further, the present invention comprises a method for protecting the surface of a composite wood product against fungal and insect attack, comprising incorporating into at least one surface layer of a multi-layered composite wood product a pesticidal amount of a first preservative composition comprising a concentration of zinc borate of at least 2.0% (m/m). In some embodiments, the concentration of zinc borate is greater than 2.0% (m/m). The multi-layered composite wood product comprises a composite-wood wall or roofing panel with an integrated resin-impregnated paper overlay on a face of the panel, a radiant barrier layer on a face of the panel, and/or an insulation layer on a face of the panel. These layers may be affixed to the bottom surface of the manufactured wood product, opposite the WRB layer (when the WRB layer is present). In one embodiment, the insulation layer may be affixed to one surface, and the radiant barrier may be affixed to the other surface.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method for producing a manufactured wood product with surface protection against fungal and insect attack, comprising:
forming, on a production line, a bottom layer of a manufactured wood mat with bottom layer lignocellulosic strands;
forming, on the production line, a core layer of the manufactured wood mat with core layer lignocellulosic strands;
forming, on the production line, a top layer of a manufactured wood mat with top layer lignocellulosic strands treated with a first elevated concentration of zinc borate; and
applying heat and pressure to the manufactured wood mat to form a manufactured wood product.

2. The method of claim 1, further comprising the steps of:
blending all the lignocellulosic strands with a base concentration of zinc borate; and
adding additional zinc borate to the top layer lignocellulosic strands sufficient to attain the first elevated concentration of zinc borate.

3. The method of claim 1, wherein the first elevated concentration is at least 2.0% (m/m).

4. The method of claim 1, wherein the first elevated concentration is greater than 2.0% (m/m).

5. The method of claim 2, further comprising the step of adding additional zinc borate to the bottom layer lignocellulosic strands sufficient to attain a second elevated concentration of zinc borate.

6. The method of claim 1, wherein the bottom layer lignocellulosic strands are treated with a second elevated concentration of zinc borate.

7. The method of claim 6, wherein the second elevated concentration of zinc borate is equal to the first elevated concentration.

8. The method of claim 1, wherein the core layer lignocellulosic strands are treated with a third concentration of zinc borate.

9. The method of claim 8, wherein the third concentration of zinc borate is less than the first concentration of zinc borate.

10. The method of claim 1, further comprising the steps of:
prior to the step of applying heat and pressure, applying a WRB layer to a top surface of the manufactured wood mat;
wherein the manufactured wood product comprises a panel with integrated WRB.

11. The method of claim 1, wherein the WRB layer comprises a resin-impregnated paper overlay.

12. The method of claim 1, further comprising the step of affixing a radiant barrier layer to a surface of the manufactured wood product.

13. The method of claim 1, further comprising the step of affixing an insulation layer to a surface of the manufactured wood product.

14. The method of claim 10, further comprising the step of affixing an insulation layer or a radiant barrier layer to a bottom surface of the manufactured wood product.

15. A method for protecting the surface of a composite wood product against fungal and insect attack, comprising:
incorporating into at least one surface layer of a multi-layered composite wood product a pesticidal amount of a first preservative composition comprising a concentration of zinc borate of at least 2.0% (m/m).

16. The method of claim 15, wherein the concentration of zinc borate is greater than 2.0% (m/m).

17. The method of claim 15, wherein the multi-layered composite wood product comprises a composite-wood wall or roofing panel with an integrated resin-impregnated paper overlay on a face of the panel.

18. The method of claim 15, wherein the multi-layered composite wood product comprises a composite-wood wall or roofing panel with a radiant barrier layer on a face of the panel.

19. The method of claim 15, wherein the multi-layered composite wood product comprises a composite-wood wall or roofing panel with an insulation layer on a face of the panel.

20. The method of claim 17, wherein the multi-layered composite wood product further comprises a radiant barrier layer or an insulation layer on a second face of the panel.
